(19) United States
(12) Patent Application Publication
(10) Pub. No.: US 2005/0049979 A1
(43) Pub. Date: Mar. 3, 2005

(54) Method, apparatus, and system for determining a fraudulent item

(76) Inventors: Timothy J. Collins, Homer Glen, IL (US); Douglas A. Kuhlman, Inverness, IL (US); Thomas S. Messerges, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 10/650,153

(22) Filed: Aug. 26, 2003

(51) Int. Cl. G06F 17/60

(52) U.S. Cl. 705/75

(57) ABSTRACT

In order to address the need for detection of fraudulent items, a method, apparatus, and system for detection of fraudulent items is provided herein. Special anti-forgery Radio-Frequency identification (RFID) tags are utilized with additional measures to thwart would-be forgers. Each anti-forgery RFID tag comprises a unique, or semi-unique number that, along with a private key possessed by only the legitimate product manufacturer, determines a signature that is preferably printed on the product packaging. Utilizing the unique number on the anti-forgery RFID and a public key corresponding to the private key, the signature is verified by standard public-key cryptographic methods. The validation of the signature identifies the product's authenticity.

### FIELD OF THE INVENTION

The present invention relates generally to fraud prevention and in particular, to a method, apparatus and system for determining a fraudulent item.

### BACKGROUND OF THE INVENTION

There is a strong desire among retailers to prevent the fraudulent copying of name-brand products and services by competitors with lower standards of quality. Such fraudulent solutions are almost always inferior. By using the same (or visually identical) packaging material (including the producer name), the fraudulent alternative not only takes advantage of any advertising done by the name-brand material but also hijacks the name of the name-brand, oftentimes fooling a consumer into purchasing the inferior product. Therefore, a need exists for a method, apparatus, and system for determining a fraudulent item so that the consumer and retailer are not fooled into purchasing fraudulent items.

### BRIEF DESCRIPTION OF THE DRAWINGS

FIG. 1 is a block diagram of a product for sale.

FIGS. 2, 3, and 4 show various forms of anti-forgery RFID tags.

FIG. 5 is a flow chart showing manufacture of a product.

FIG. 6 is a flow chart showing the verification of a product.

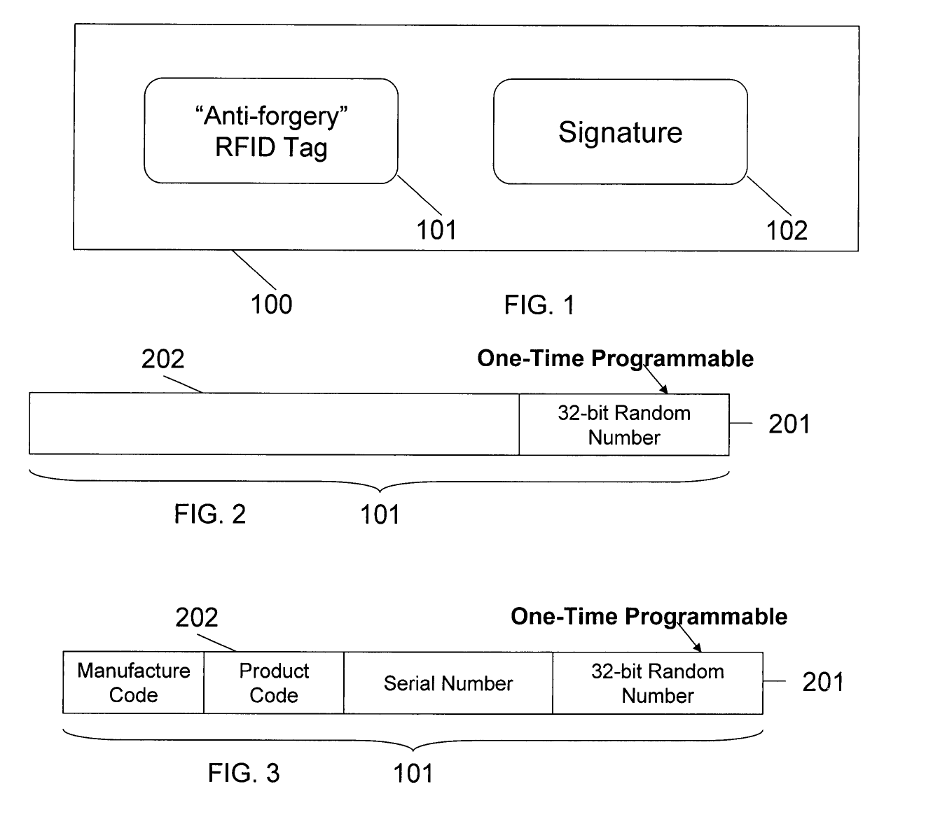

### DETAILED DESCRIPTION OF THE DRAWINGS

In order to address the need for detection of fraudulent items, a method, apparatus, and system for detection of fraudulent items is provided herein. Special anti-forgery Radio-Frequency identification (RFID) tags are utilized with additional measures to thwart would-be forgers. Each anti-forgery RFID tag comprises a unique, or semi-unique number that, along with a private key possessed by only the legitimate product manufacturer, determines a signature that is preferably printed on the product packaging. Utilizing the unique number on the anti-forgery RFID and a public key corresponding to the private key, the signature is verified by standard public-key cryptographic methods. The validation of the signature identifies the product's authenticity.

During manufacture of a product, the manufacturer obtains an anti-forgery RFID. This “anti-forgery” RFID tag has properties that allow it to be distinguished from a normal, commercially-available RFID tag, and comes pre-programmed with some amount (e.g., 32 bits) of unalterable, rarely-repeating information. The manufacturer associates this RFID with one of its products by programming information specific to the product into programmable fields of the RFID tag. The total information content of the RFID, which includes the unalterable, rarely-repeating information and the product specific information, is digitally signed via a standard public-key cryptographic process. The signature is preferably printed on the item or packaging. In order to determine a product's authenticity, an individual utilizes the public key corresponding to the manufacturer and the total information content on the RFID, and verifies the signature. Because the signature is produced via a cryptographic process and a special anti-forgery RFID tag is used, it is virtually impossible for a forger to generate a valid signature for forged product for the following reasons:
1. The forger does not possess the private key of the legitimate manufacturer.
2. In all likelihood, the unalterable, rarely-repeating information on the legitimate product's anti-forgery RFID tag will be different than on the forger's anti-forgery RFID tag (so an exact copy of a signature for a legitimate product's already signed RFID tag will likely not be possible).
3. The anti-forgery tag cannot be copied using a normal, commercially available RFID tag because, by definition, it would be distinguishable from the anti-forgery RFID tag.
4. It is difficult for a forger to fabricate his own anti-forgery RFID tag (only a few semiconductor companies in the world have this capability).

Turning now to the drawings, wherein like numerals designate like components, FIG. I is a block diagram of product 100. Product 100 may comprise any product where the manufacturer wishes to prevent against forgery. For example, product 100 might comprise a musical CD, a DVD, shampoo, soap, cologne, etc. As is evident, product 100 comprises an “anti-forgery” RFID tag 101 and signature 102. In a first embodiment of the present invention anti-forgery RFID tag 101 is affixed to the packaging of product 100 while signature 102 is printed onto the packaging. However, in alternate embodiments of the present invention, signature 102 may be part of RFID tag 101. Signature 102 is preferably printed onto the packaging or the actual product in bar-code form. An example of a suitable bar-code format is the public domain small Aztec 2-D barcode that can encode up to 95 characters (The “ISS-Aztec Code” specification is available from: AIM USA, 634 Alpha Drive, Pittsburgh, Pa. USA 15238-2808).

Anti-forgery RFID 101, as shown in FIG. 2, is preferably a common RFID tag as known in the art, except that it is distinguishable from normal, commercially-available RFID tags and it contains a pre-programmed, preferably one-time programmable number 201 with some amount (e.g., 32 bits) of unalterable, rarely-repeating information (e.g. the hex sequence fe482cc0 only appears on 2⁻³² of all RFID tags printed). For example, anti-forgery RFID 101 may comprise an RFID such as described in U.S. Pat. No. 4,818,855 issued to Mongeon et al., entitled, Identification System, disclosing a remotely powered identification device which derives power from a remote source via on of electric field or magnetic field and which transmits stored information back to a source via the electric field or magnetic field. RFID 101 additionally comprises second portion 202 that is utilized by a manufacturer to store product information. For example, as shown in FIG. 3, such product information may be in the form of an Electronic Product Code (EPC) having 96-bits of identification data as outlined by David L. Brock in “The Electronic Product Code,” MIT-Auto ID Center, January 2001. The EPC may include a manufacturer code, product code, serial number, etc.

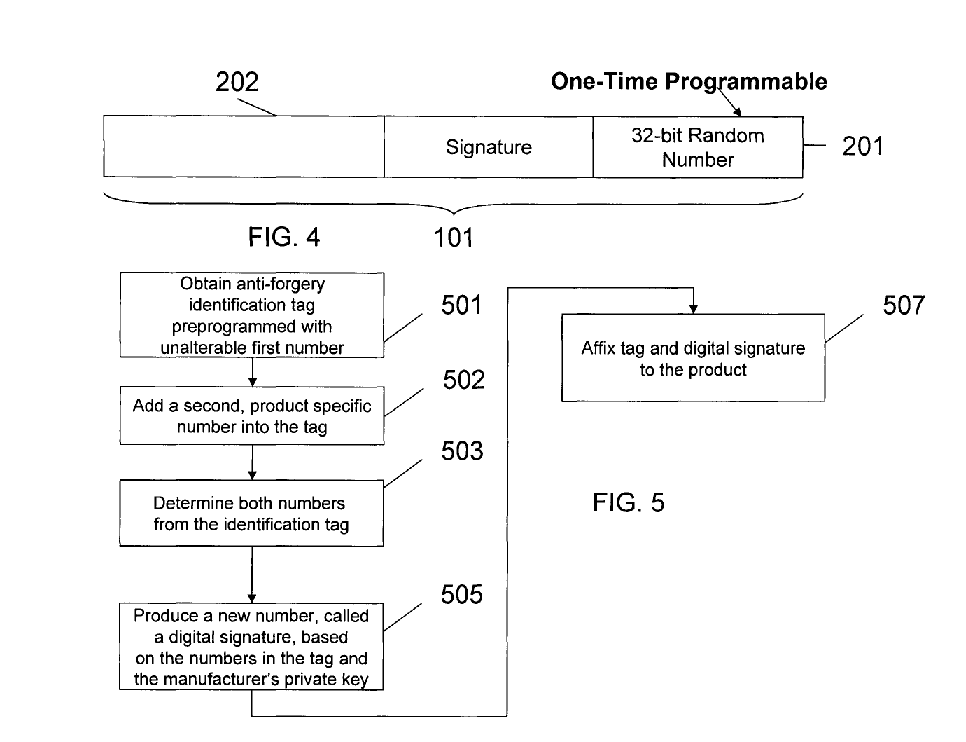

As discussed above, signature 102 is printed in bar code form, however, if there was enough capacity in RFID tag 101, signature 102 can also be stored there as shown in FIG. 4. During manufacture, or packaging of product 100, the manufacturer would obtain an anti-forgery RFID tag, determine a desired EPC for his product, program this EPC into the tag (i.e., stored number 201), and then determine stored number 202. The manufacturer would then use a cryptographic process and a private key to generate signature 102 of the two stored numbers 201 and 202. The generation of signature 102 could be done via several cryptographic means as known in the art. For example, the signature could be done in the classic RSA method. The stored numbers 201 and 202 are cryptographically hashed (e.g., using SHA-1). This hash is converted to an integer and suitably padded, which is raised to the private key value of the manufacturer. The result is taken modulo n, where n is the product of two large primes (typically, 512 bits in size each, or more). Those skilled in the art will recognize that a number of different signature methods are possible—Elliptic-Curve Digital Signature Algorithm (ECDSA), Digital Signature Algorithm (DSA), short signatures of Boneh-Lynn-Shacham, etc. In the preferred embodiment of the present invention a DSA signature is utilized to produce a 320-bit signature.

In order to verify a products authenticity, a forgery detector (or reader) reads both anti-forgery RFID 101 (including values 201 and 202) and corresponding signature 102. The detector first verifies that RFID 101 is indeed an anti-forgery RFID and not some other commercially available RFID. If so, it then checks to see if signature 102 verifies for that particular RFID (i.e., RFID 101). Since the key needed to verify a signature (i.e., the public key) does not help produce a signature, the general availability of readers is not a concern to manufacturers. It is important, however, that the public key in the readers is the key that corresponds to the private key used by the manufacturers.

A further step at security may comprise protecting RFID 101 with a symmetric encryption key so that it becomes difficult for a forger to program new values into purchased RFID tags. As long as the symmetric key stayed secret, a potential forger would be relegated to only cloning known “good” values and could not create new, legitimate-seeming ID values to program into purchased RFIDs. Keeping the symmetric key secret would be nearly impossible, however, as it would need to put into every reader used by every forgery detector entity, meaning its compromise would be likely. Again, some minor modifications, using some keys for certain IDs and different keys for different IDs, all maintained by some remote server, would add a degree of security to the anti-forgery vehicle.

FIG. 5 is a flow chart illustrating the manufacture of a product. The logic flow begins at step 501 where a manufacturer obtains an anti-forgery identification tag comprising a first number. The first number is preferably a unique or semi-unique unalterable number existing on the anti-forgery RFID tag, however, in alternate embodiments, the first unique or semi-unique number can be determined from a unique characteristic of the item's manufactured material. For example, an item can have a unique pattern painted upon it, where in the unique pattern, is read using a laser to determine the unalterable number. Another example may be to impregnate the unique number into the material then use a laser type device to determine the random number. At step 502, the manufacturer adds a second product specific number into the tag. At step 503, the manufacturer determines both numbers from the tag and produces a new number based on these first two numbers (step 505). As discussed above, the new number is a digital signature of the first two numbers that is produced using a cryptographic process and a private key to facilitate easy verification. Additionally, cryptographic verification of the signature insures the product's authenticity. Finally, at step 507, both the tag (containing the first two numbers) and the new number (i.e., the digital signature) are affixed to the product. In the preferred embodiment, the anti-forgery RFID (comprising the first two numbers) is affixed to the packaging of the product, while the signature is simply printed (in bar-code form) onto the packaging of the product. It should be noted, however, that if memory exists within the RFID tag, the signature may be stored there, affixed directly to the product itself, or otherwise indelibly bound to the product to be protected.

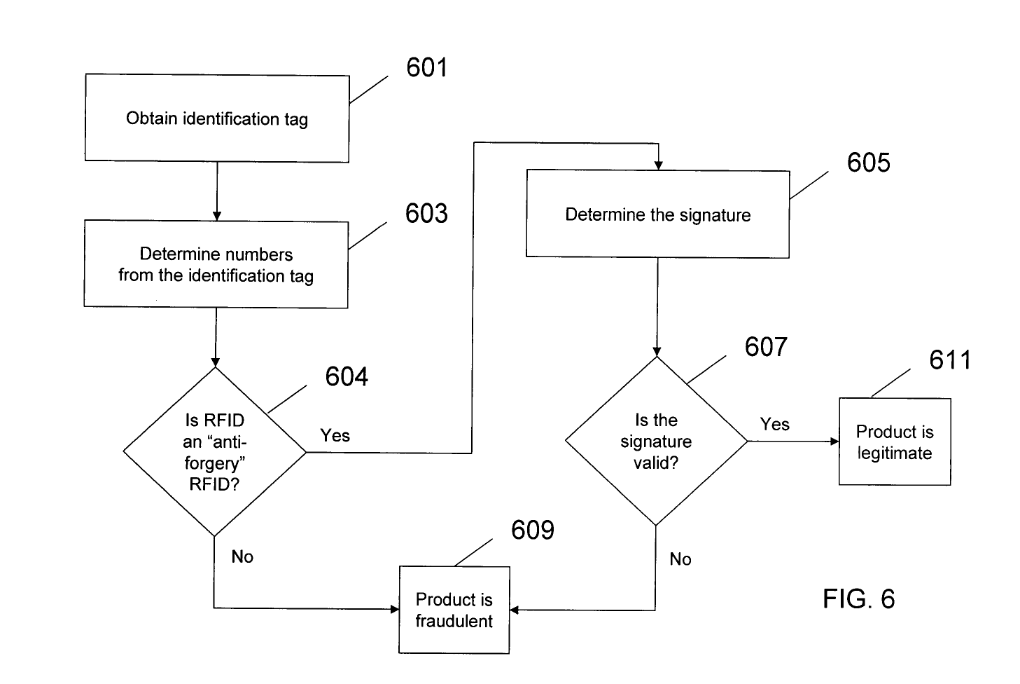

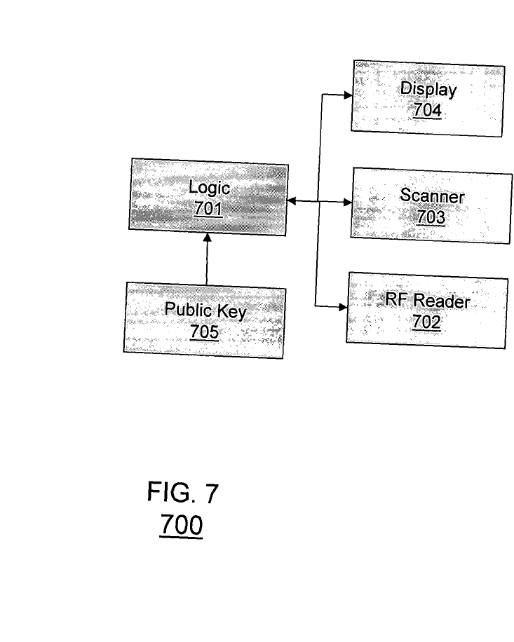

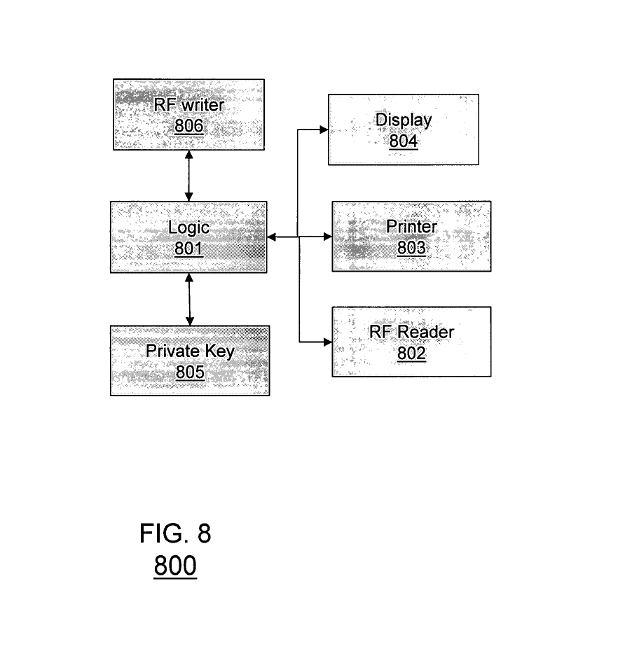

FIG. 6 is a flow chart showing the verification of a product. The logic flow begins at step 601 where an identification tag associated with an item or its packaging is obtained and the numbers existing on the identification tag are determined (step 603). In one embodiment of the present invention all “anti-forgery” RFID tags contain some distinguishing characteristic that identifies them as legitimate in order to prevent forgers from forging RFID tags. This information may, for example, be a specific physical feature, such as color or shape, or a behavioral feature such as how the tag operates. Thus in one embodiment of the present invention the RFID tag is verified to be a special “anti-forgery” RFID tag, with the necessary distinguishable properties (step 604), however, in alternate embodiments of the present invention step 604 need not be executed. If, at step 604, the verification fails, then the logic flow ends at step 609 and the product is determined to be fraudulent. Otherwise, flow continues to step 605 where the signature associated with the item or its packaging is determined. Preferably the signature is printed upon to item or its packaging in a way that it can be electronically read (e.g., using a barcode scanner device). As discussed above, the signature must be cryptographically verified in order to insure the product's authenticity. At step 607 an attempt is made to verify the signature. If the signature is not valid then the logic flow ends at step 609 where the product is determined to be fraudulent. Otherwise, the flow ends at step 611 where the product is determined to be legitimate. In particular, a cryptographic process and the contents of the RF tag are utilized with a public key to cryptographically verify the signature. As discussed above, this attempt may comprise one of many standard cryptographic verification techniques. For example, continuing the RSA example above, the same cryptographic hash of the first two numbers is performed. The signature is raised to the public key value and the result taken modulo the same n as was used in the signing process. If this value matches the padded hash value, then the signature verifies. Else, it is rejected as invalid. Similar verification techniques are used for ECDSA, DSA, or other cryptographic signature methods.

FIG. 7 is a block diagram of scanning unit 700. As is evident, scanning unit 700 comprises logic circuitry 701, RF tag reader 702, scanner 703, and display 704. Logic circuitry 701 preferably comprises a microprocessor/controller, while RF reader 702 is a RF tag reader, as known in the art, that is capable of distinguishing anti-forgery RFIDs from normal, commercially available RFIDs. Similarly scanner 703 comprises well-known bar-code scanning circuitry, while display 704 preferably comprises a means to indicate whether or not a scanned product is a forgery and a means to display the type of product being scanned (e.g., a musical CD, a DVD, shampoo, soap, cologne, etc.). For example, display 704 might simply comprise a green or red LED that indicates whether a product is a forgery, but preferably, may comprise a CRT, giving more-detailed graphical data about the product type and authenticity. The reason for displaying the product type is to prevent a forger from removing a valid tag from a cheap product and placing it and a copy of the signature on a more expensive product, thereby making the more expensive product appear to be valid. By displaying the product type information, a user can visually verify that the displayed product type corresponds to the actual product. The product type information (e.g., the EPC) is contained in the RFID (e.g., the product information field 202 of FIG. 2.)

During operation, RF reader 702 reads the RF tag and provides the tag's content to logic circuitry 701. In a similar manner, scanner 703 scans the product or its label to determine the value of the signature. The value of the signature is provided to logic circuitry 701. Logic circuitry 701 then utilizes public key 705 and a cryptographic algorithm to verify the signature. The product type information and the result of the verification steps (i.e., the signature validation and verification of the anti-forgery properties of the RFID—see flowchart in FIG. 6) are output to display 704.

FIG. 8 is a block diagram of signature determination circuitry 800. As discussed above, during manufacture or packaging of an item, a signature is produced that must be cryptographically verified in order to show the product's authenticity. As shown, circuitry 800 comprises logic circuitry 801, RF reader 802, printer or RF writer 806, and display 804. Logic circuitry 801 preferably comprises a microprocessor/controller, while RF reader 802 is a standard RF tag reader, as known in the art, that is capable of reading anti-forgery RFIDs. Similarly printer 803 comprises either standard printing equipment to print on packaging, or actual manufactured items, while RF writer comprises well-known circuitry to write information to RF tags. Finally while display 804 preferably comprises any means to indicate status information for circuitry 800. During operation, an RFID tag is provided to circuitry 800 and read by RF reader 802 to determine the total information content on the RF tag. This information is then provided to logic circuitry 801, where logic circuitry 801 accesses private key 805 and based on the private key, produces a cryptographic signature. The cryptographic signature is either provided to printer 803 where it is printed upon the item or package. It should be noted that in an alternate embodiment, the signature may be provided to RF writer 806 to be written to the RF tag. Regardless of whether or not the signature is printed or written to the RF tag, logic circuitry 801 instructs RF writer 806 to write product information to the RF tag.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for determining if an item is a fraudulent item, the method comprising the steps of:
obtaining a first number associated with the item or item's packaging;
obtaining a second number associated with the item or item's packaging;
utilizing a cryptographic process and the first number to cryptographically verify the second number; and
determining the product's authenticity based on the verification.

2. The method of claim 1 wherein the step of obtaining the fist number comprises the step of obtaining the first number from an RFID tag associated with the item or the item's packaging.

3. The method of claim 1 wherein the step of obtaining the second number comprises the step of determining a cryptographic signature printed on the item or the item's packaging.

4. The method of claim 1 wherein the step of utilizing the cryptographic process comprises the step of utilizing a public key and the first number to verify the second number.

5. The method of claim 1 wherein the step of determining the products authenticity comprises the step of associating the product with an authentic product if the signature is verified, otherwise associating the product with a forged product.

6. A method of manufacturing a product in order to prevent forgery, the method comprising the steps of:
obtaining a tag comprising a first number;
determining a second number utilizing the first number and a cryptographic process, wherein cryptographic verification of the second number insures the product's authenticity;
affixing the first number to either the product or the packaging associated with the product; and
affixing the second number to either the product or the packaging associated with the product.

7. The method of claim 6 wherein the step of obtaining the tag comprising the first number comprises the step of obtaining an RFID tag comprising a unique, or semi-unique unalterable number.

8. The method of claim 6 wherein the step of affixing the second number to either the product or the packaging associated with the product comprises the step of printing a cryptographic signature on the product or the product's packaging.

9. The method of claim 6 wherein the step of determining the second number utilizing the first number and a cryptographic process comprises the step of utilizing the first number and a private key to generate the second number.

10. A method comprising the steps of:
obtaining a first number from an RFID tag associated with an item;
obtaining a second number printed on the item or the item's packaging;
utilizing a public key and the first number to verify the second number; and
determining the item's authenticity based on the verification.

11. A method comprising the steps of:
obtaining an RFID tag comprising a first number;
utilizing a private key and the first number to create a second number such that cryptographic verification of the second number insures a product's authenticity; and
affixing the second number and the RFID tag to the item or the item's packaging.

12. An RFID tag comprising:
a first portion comprising product identification information; and
a second portion comprising an unalterable random or semi-random number, wherein the unalterable random or semi-random number is utilized along with a cryptographic signature to verify a products authenticity.

13. The RFID tag of claim 12 wherein the first portion comprises a product code or a serial number or a manufacturer code.

14. The RFID tag of claim 12 further comprising the cryptographic signature.

15. A product scanner comprising:
an RF tag reader outputting contents of an RF tag;
a scanner outputting a cryptographic signature; and
logic circuitry having the contents of the RF tag and the cryptographic signature as an input and outputting information as to whether an item is a forgery.

16. The product scanner of claim 15 wherein the logic circuitry utilizes a public key and cryptographic operations to verify the cryptographic signature.

17. An apparatus comprising:
an RF reader outputting contents of an RF tag;
logic circuitry having the contents of the RF tag as an input and outputting a cryptographic signature; and
printing circuitry having the cryptographic signature as an input and printing the cryptographic signature upon an item or packaging.

18. The apparatus of claim 17 further comprising:
an RF writer outputting product information for the item to the RF tag.
